(19) United States
(12) Patent Application Publication
(10) Pub. No.: US 2024/0406951 A1
(43) Pub. Date: Dec. 5, 2024

(54) SYSTEM AND METHOD FOR PERFERENTIAL SCHEDULING FOR C-V2X ADAPTIVE OUT-OF-BAND INTERFERENCE

(71) Applicant: Ford Global Technologies, LLC, Dearborn, MI (US)

(72) Inventor: Syed Amaar Ahmad, Canton, MI (US)

(21) Appl. No.: 18/325,285

(22) Filed: May 30, 2023

(51) Int. Cl. H04W 72/1263; H04W 72/02; H04W 72/0446; H04W 72/0453

(52) U.S. Cl. CPC H04W 72/1263; H04W 72/02; H04W 72/0446; H04W 72/0453

(57) ABSTRACT

A system includes an antenna and a controller. The controller is configured to detect a size of a data packet to be transmitted, and detect transmission availability among a set of primary subchannels. With a scheduler in a selective excluded resource mode, the controller identifies CSR for transmitting the data packet based on the primary subchannels in response to at least one of the size of the data packet being less than a packet size threshold and at least a portion of the primary subchannels being available to transmit the data packet; and identifies the CSR for transmitting the data packet based on the plurality of subchannels in response to at least one of the size of the data packet being greater than or equal to the packet size threshold and the primary subchannels not being available to transmit the data packet.

### TECHNICAL FIELD

Aspects of the disclosure generally relate to adaptive out-of-band interference in cellular vehicle-to-everything communication.

### BACKGROUND

Vehicles may broadcast basic safety messages (BSMs) according to the 3rd Generation Partnership Project (3GPP) release 14/15 cellular vehicle-to-everything (C-V2X) standard. This is sometimes referred to as the long-term evolution (LTE) vehicle-to-everything (V2X). These messages may be broadcast in the frequency range of 5905-5925 MHZ, and may be used for applications such as object evasion. The Unlicensed National Information Infrastructure (U-NII) radio band 4 (U-NII-4) is part of the radio frequency spectrum used by wireless local area network (WLAN) devices. Messages may be broadcast over this protocol in the frequency range of 5850-5895 MHz.

### SUMMARY

In one form, the present disclosure is directed to a system for scheduling communications using a plurality of wireless interfaces. The system includes an antenna configured to send and/or receive data over a message protocol having a plurality of subchannels. The plurality of subchannels includes a set of primary subchannels and a set of secondary subchannels, where the set of primary subchannels are less susceptible to out-of-band interference than the set of secondary subchannels. The system further includes a controller configured to employ a scheduler operable in a selective excluded resource mode. The controller is configured to detect a size of a data packet to be transmitted, and detect transmission availability among the set of primary subchannels. With the scheduler in the selective excluded resource mode, the controller is further configured to:

identify one or more candidate subframe resources (CSR) for transmitting the data packet based on the set of primary subchannels in response to at least one of the size of the data packet being less than a packet size threshold and at least a portion of the set of primary subchannels being available to transmit the data packet; identify the one or more CSR for transmitting the data packet based on the plurality of subchannels including the set of primary subchannels and the set of secondary subchannels in response to at least one of the size of the data packet being greater than or equal to the packet size threshold and the set of primary subchannels not being available to transmit the data packet. The controller is further configured to transmit the data packet based on the one or more CSR.

In one form, the present disclosure is directed to a method for scheduling communications using a plurality of wireless interfaces. The method comprising detecting a size of a data packet to be transmitted via an antenna. The antenna is configured to send and/or receive data over a message protocol having a plurality of subchannels, the plurality of subchannels including a set of primary subchannels and a set of secondary subchannels. The set of primary subchannels are less susceptible to out-of-band interference than the set of secondary subchannels. The method further includes: detecting transmission availability among the set of primary subchannels; identifying, by a scheduler in a selective excluded resource mode, one or more candidate subframe resources (CSR) for transmitting the data packet based on the set of primary subchannels in response to at least one of the size of the data packet being less than a packet size threshold and at least a portion of the set of primary subchannels being available to transmit the data packet; identifying, by the scheduler in the selective excluded resource mode, the one or more CSR for transmitting the data packet based on the plurality of subchannels including the set of primary subchannels and the set of secondary subchannels in response to at least one of the size of the data packet being greater than or equal to the packet size threshold and the set of primary subchannels not being available to transmit the data packet; and transmitting the data packet based on the one or more CSR.

### BRIEF DESCRIPTION OF THE DRAWINGS

FIG. 1 illustrates an example system for scheduling vehicle communications using a plurality of wireless interfaces;

FIG. 2 illustrates an example of a plurality of vehicles and a U-NII-4 device producing interference;

FIG. 3A illustrates an example of a schedule for an intelligent transportation system (ITS) band with excluded resources;

FIG. 3B illustrates an example of a schedule for the ITS band without excluded resources;

FIG. 4 illustrates a flowchart for a selective excluded resource mode of a scheduler for a V2X controller; and

FIG. 5 illustrates an example computing device for the V2X controller.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present approach.

C-V2X technology has become increasingly popular in the automobile industry. V2X operations can provide valuable real-time traffic information, mapping, traffic light signaling, and tolling services as part of an ITS. However, the operation of Wi-Fi or other unlicensed devices in neighboring frequency bands near a V2X device may disrupt and deteriorate the Quality-of-Service (QOS) because of out-of-band emissions (OOBE) may introduce interference.

OOBE from a U-NII-4 device (e.g., operating in the frequency range of 5850-5895 MHz) may cast interference in the ITS band (e.g., operating in the frequency range of 5905-5925 MHZ). Similarly, OOBE from a U-NII-5 device (e.g., operating in the frequency range of 5925-6425 MHz) may cast interference in the ITS band. Thus, C-V2X messaging may be vulnerable to U-NII-4 and U-NII-5 interference, especially at lower and upper ends of the ITS band. In the following. U-NII bands that may interfere with the ITS band, such as the U-NII-4 and U-NII-5 bands, may collectively be referred to as “U-NII bands”

C-V2X scheduling can accommodate intra-C-V2X traffic due to its semi-persistent nature. However, C-V2X scheduling has difficulties handling OOBE from U-NII/Wi-Fi devices due to their spontaneous nature. These OOBE may be more probable near band edges, but may not always be so located.

Aspects of the disclose provide a scheduling approach to prevent or reduce incidence of OOBE interference. In particular, a C-V2X scheduler may be enhanced to determine when to exclude or include these susceptible subchannels. In an example, this approach may be implemented into the J3161 C-V2X standard to add robustness to interference.

As detailed herein, the scheduling approach may include employing specific subchannels (i.e., a set of primary subchannels having one or more subchannels) that are most likely to experience less OOBE interference than other subchannels (i.e., a set of secondary subchannels having one or more subchannels). Unless certain conditions are met, such as data packet size or transmission availability, the other subchannels may not be employed for transmitting data packets, such as but not limited to BSM messages. Notably, omission of certain subchannels during scheduling may be performed regardless of whether interference is actually detected. By adopting such an approach, C-V2X may become resilient and robust against undesired interference while still being able to accommodate transmission for large data packets and/or during congested communication periods.

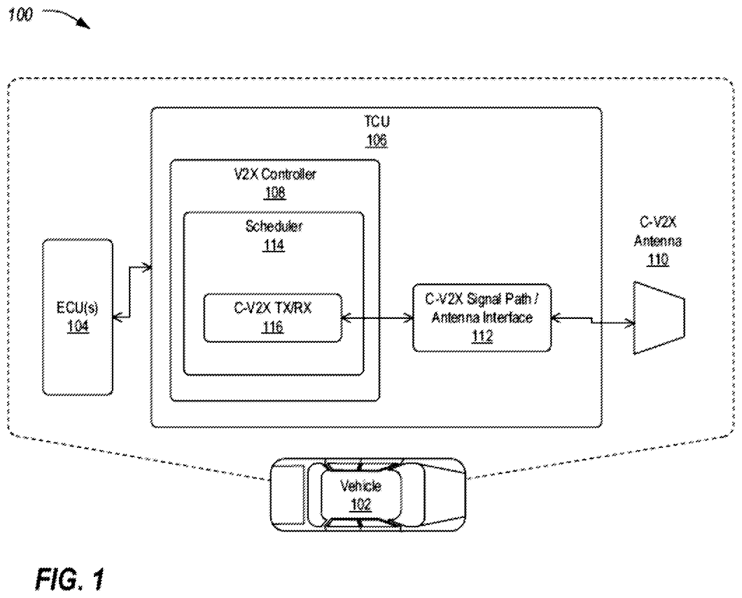

FIG. 1 illustrates an example system 100 for a vehicle 102 configured to reduce or prevent OOBE interference in C-V2X communications. A telematics control unit (TCU) 106 may be connected to one or more electronic control units (ECUs) 104 (e.g., over one or more vehicle buses). The TCU 106 may include a V2X controller 108 that hosts a scheduler 114 for C-V2X communications. The scheduler 114 may utilize a C-V2X transmitter/receiver (TX/RX) 116 to transmit and/or detect signals via a C-V2X antenna 110. While an example system 100 is shown in FIG. 1, the example components as illustrated are not intended to be limiting.

In a non-limiting example, the vehicle 102 may be an automobile, a crossover utility vehicle (CUV), a sport utility vehicle (SUV), a truck, a recreational vehicle (RV), a boat, a plane, or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors. In another example, the vehicle 102 may be a pure electric vehicle driven by electric motors only.

The plurality of ECUs 104 may be configured to perform and manage various vehicle 102 functions under the power of the vehicle battery and/or drivetrain. As some non-limiting examples, the ECUs 104 include: a powertrain control module (PCM) configured to control engine and transmission components; an antilock brake system (ABS) controller configured to control brake and traction control components; an electric power-assisted steering (EPAS) controller configured to control steering assistance and adjust pull or drift compensation functions; advanced driver assistance systems (ADAS) such as adaptive cruise control or automate braking; and a headlamp control module (HCM) configured to control light on/off settings. The ECUs 104 may also include other powertrain or chassis components, an infotainment system configured to support voice command and BLUETOOTH interfaces with the driver and driver carry-on devices, electromechanical body controllers such as window or lock actuators, and trailer controller components such as light control and sensor data to support connected trailers. The plurality of ECUs 104 may share physical hardware, firmware, and/or software, such that the functionality from multiple ECUs 104 may be integrated into a single ECU 104 or distributed across a plurality of ECUs 104.

The TCU 106 may be configured to support communications between the vehicle 102 and other devices. These communications may be performed over various communications protocols and for various purposes. In one example the TCU 106 may support V2X communications via the V2X controller 108. The illustrated configuration is a single antenna configuration, having a C-V2X antenna 110 connected to the V2X controller 108 via a C-V2X signal path and antenna interface 112. It should be noted that this is only an example, and TCUs 106 configured with more, fewer, and different protocols of communications interfaces and antennas are possible. In another example, the vehicle 102 may include multiple antennas, such as a Wi-Fi antenna configured to send and receive Wi-Fi transmissions.

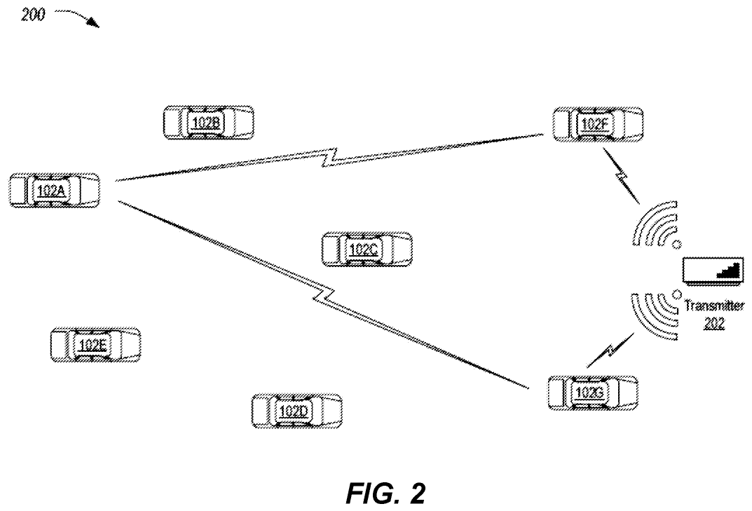

FIG. 2 illustrates an example 200 of a plurality of vehicles 102 and a U-NII device 202 producing interference. As shown, the plurality of vehicles 102 includes seven vehicles 102A-102G distributed across an area. In a non-limiting example, the vehicles 102A-102G may transmit and receive BSMs every 100 milliseconds.

In the example 200, the U-NII device 202 is located closer to vehicles 102F-102G than to the vehicle 102A-102E. Due to their closer proximity to the U-NII device 202, the vehicles 102F-102G may suffer interference because of U-NII transmissions emanating from the U-NII device 202. Thus, OOBE from the U-NII device 202 may cause undesirable interference to the vehicles 102F-102G. As the vehicles 102A-102E are further from the U-NII device 202, the OOBE from the U-NII device 202 may be less severe for the other vehicles 102A-102E. In fact, the vehicles 102A-102E may be unaware of the interference from the U-NII device 202.

The OOBE may also be stronger for C-V2X near the band edge between ITS band and U-NII band. Thus, if the vehicles 102A-102E use the lower subchannels near 5905 MHz, it may be more difficult for the vehicles 102F-102G to hear these messages due to higher OOBE undesirable interference. As the vehicles 102A-102E may be unaware of the interference from the U-NII device 202, the vehicles 102A-102E may not have a reason to prefer the higher C-V2X subchannels. Yet, if a BSM is transmitted in the band that experiences the least OOBE, then the undesirable effect of the interference may be minimized.

The V2X controller 108 may include the scheduler 114 to schedule transmission of data packets such as a BSM using selected subchannels. The scheduler 114 may be configured to schedule communications via the C-V2X antenna 110, and the C-V2X TX/RX 116 may be configured to monitor the transmission and reception of messages via the C-V2X antenna 110.

Using the C-V2X TX/RX 116, the scheduler 114 may be made aware of history of received and transmitted data packets and also may be aware of their time slots (e.g., of 1 ms) and their subchannels over C-V2X.

The scheduler 114 is configured to schedule transmission of a data packet using one or more subchannels at a selected subframe. More particular, the scheduler 114 is operable in a selective excluded resource mode and, if applicable in, an unrestricted mode. During the selective excluded resource mode, the scheduler 114 is configured to schedule transmission of the data packet employing a set of primary subchannels unless certain conditions are met resulting in the use of a set of secondary subchannels in addition to the primary subchannels.

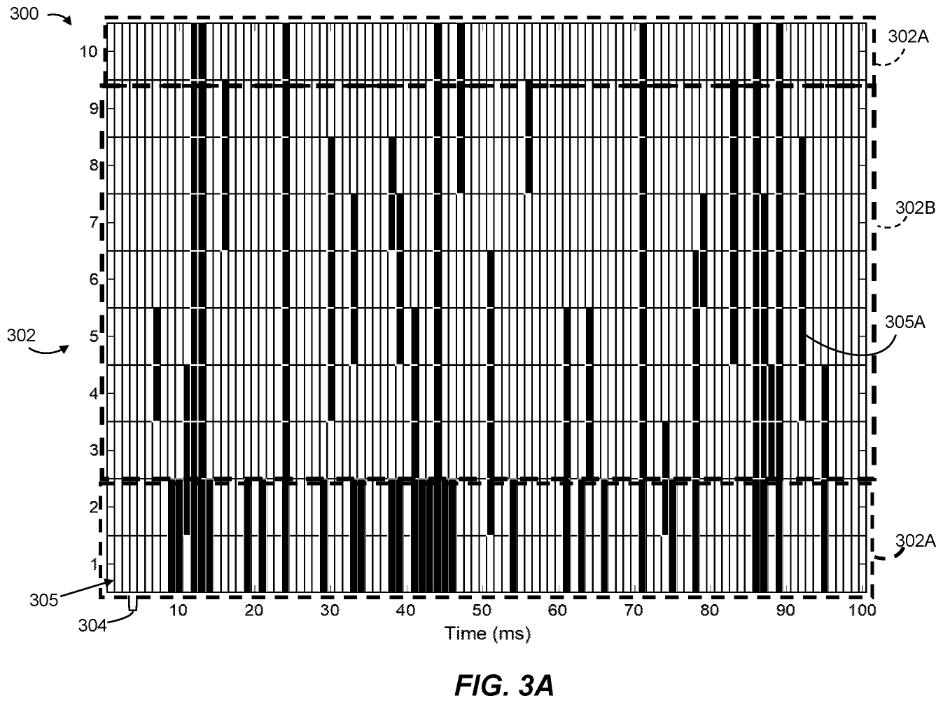

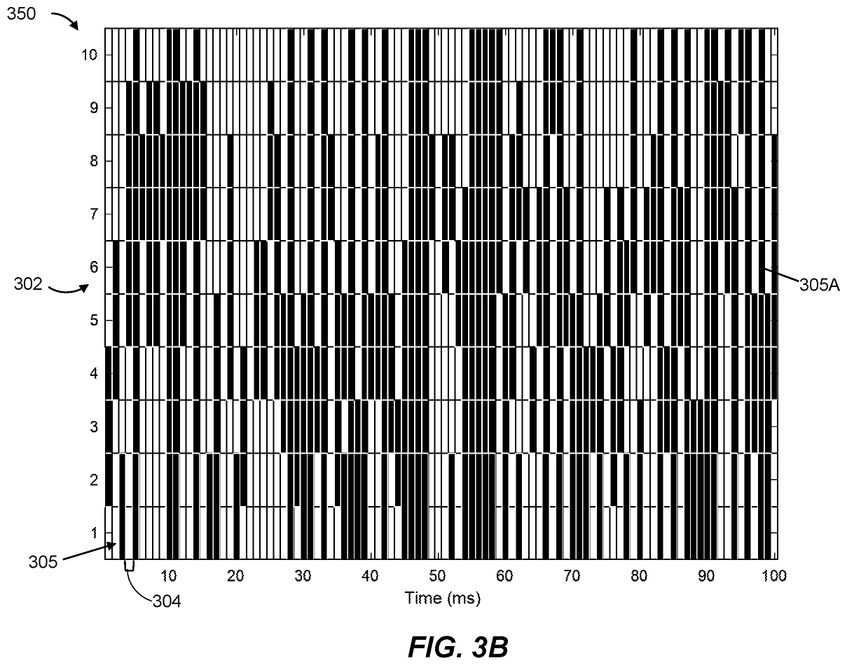

Referring to FIGS. 3A and 3B an example operation of the scheduler 114 in the selective excluded resource mode is provided. In FIG. 3A, a schedule 300 illustrates the ITS band having a plurality of subchannels 302 (e.g., subchannels 1-10 as shown along the Y axis), where the schedule 300 is defined by timeslots or, in other words, subframes 304 having 1 ms duration for transmitting a data packet. The ITS band is divided in multiple resource blocks (RB) 305, each RB 305 being 180 kHz wide for 1 ms.

More particularly, the 20 MHz ITS band 5905-5925 MHz may be divided into ten contiguous subchannels 302, each of 0.18 MHZ (e.g., 18 MHz within the 20 MHZ). A subchannel 302 may be composed of a group of adjacent RBs 305 in the same subframe 304. In the following RBs 305 for the subframes 304 may be referred to as a subframe resource, and subframe resources that can be selected for transmission is provided as candidate subframe resources (CSR) and collectively as CSR pool.

To select a subchannel 302, a J3161 standard scheduler 114 may make a list, L1, of CSRs in the selection window [T; T+n], where T corresponds to the time that the scheduler 114 requires the radio resource to perform transmission and n is the maximum tolerable latency. Packets may be scheduled for transmission in contiguous 2, 3 . . . , 10 subchannels 302 in these subframe resources, depending on the packet size from the CSRs that are generated by each C-V2X device as per LTE V2X standard rules. A packet may occupy a selected CSR where the bandwidth size of a CSR in terms of its resource blocks will increase with the packet byte size. That is, a larger packet may therefore require more resource blocks than a smaller packet. A BSM, for instance, may typically require two subchannels. A packet having more data than a BSM may require a greater allocation of resources.

From among the plurality of subchannels 302, the scheduler 114 is configured to define the set of primary subchannels and the set of secondary channels, where the set of primary subchannels are less susceptible to OOBE than the set of secondary subchannels. In a non-limiting example, in FIG. 3A, subchannels located near uppermost and/or lowermost portion of the ITS band may be susceptible to interference from the U-NII bands. Specifically, subchannels 1 and 2 may be susceptible to interference by U-NII-4 emissions and subchannel 10 may be susceptible interference from U-NII-5 emissions. Accordingly, a set of secondary subchannels 302A may include subchannels 1, 2, and 10 and a set of primary subchannels 302B includes subchannels 3 to 9.

In one form, to define the set of secondary subchannels 302A and the set of primary subchannels 302B, the scheduler 114 is configured to identify “N” pool of subchannels 302 in a lowermost and/or uppermost most portion of the ITS band that are susceptible to spontaneous OOBE interference. “N” is a number that may be different or the same for the lowermost and/or uppermost portions of the ITS band. In the following, “N_{LB}” is used to represent “N” for lowermost portion of the ITS band and “N_{UB}” is used to represent “N” for lowermost portion of the ITS band. These portions that are susceptible to OOBE and may be referred to as excluded resources (ER).

For example, in FIG. 3A, N_{LB} is 2 for the lowermost band and N_{UB} is 1 for uppermost band. The value of N may be based on the amount of interference being detected via the C-V2X TX/RX 116 and may be increased or decreased. For example, if interference from U-NII-4 band decreases, whereas interference from U-NII-5 increases, the N_{LB} may be decreased to 1 and the N_{UB} associated with the uppermost band may be two. In another example, if no interference is detected from U-NII-5 band, N_{UB} may be set to zero.

In addition to or in lieu of the OOBE, the value of N may be determined based on a function of the size of data packet and a C-V2X ProSe Per-Packet Priority (PPPP) value, where the lower a PPPP value, the higher the priority level. The PPPP may be assigned to the data packet based on various priority factors, such as type of data packet, source and destination of the data packet, or the application that is sending or intended to receive the data packet.

For example, a packet of 1000 bytes, which may employ 5 subchannels due to its size may be assigned a PPPP value of 2. In this example, the scheduler 114 may prevent use of the N=4 lowest subchannels. Yet, the same data packet transmission given a PPPP value of 6, may instead be scheduled not to use the N=3 lowest subchannels. Similarly, in another example with a BSM packet, which is less than 400 bytes and using 2 subchannels, and a PPPP value 5, N may be set to 2, but with a PPPP value of 2, the schedule may set N to 5.

In addition to or in lieu of identifying subchannels 302 at the lowermost and/or uppermost portion of the ITS band as part of the set of secondary subchannels 302A, the scheduler 114 may identify subchannels 302 that are known to be susceptible to spontaneous interference. For example, if subchannel 5 of FIG. 3A is suspectable to interference, the scheduler 114 identifies the subchannel 5 as part of the set of secondary subchannels 302B. In some examples, the scheduler 114 of a subject vehicle 102 may obtain information regarding OOBE interference from other vehicles 102. Specifically, a vehicle 102 detecting OOBE undesirable interference may indicate so in its transmitted BSMs. This may be accomplished, in an example, through including this information into a special embedded field of the BSM.

In another example, the scheduler 114 may obtain information regarding OOBE interference based on historical data associating specific locations (e.g., global navigation satellite system (GNSS) coordinates) with high OOBE communication environments. The historical data may include information regarding subchannels 302 that experience OOBE interference which is employed to define the set of secondary subchannels 302A. In yet another example, the scheduler 114 may receive an input from a user indicating that there is a high OOBE communication environment which can be used to increase N_{LB} and/or N_{UB}. Accordingly, number of subchannels 302 in the set of secondary subchannels 302A and in the set of primary subchannels 302B is adjustable. In addition, the specific subchannels 302 identified for the set of secondary subchannels 302A and the set of primary subchannels 302B may change.

The scheduler 114, in the selective excluded resource mode, is configured to schedule data packet transmission based on conditions indicative of congestion, such as data packet size and transmission availability, and not solely based on interference itself. That is, congestion refers to the condition when a data packet simply cannot be fitted or scheduled within any available subframe 304 of the set of primary subchannels 302B (i.e., within a CSR defined by the set of primary subchannels 302B). The scheduler 114 is able to schedule transmission of different size data packets and mixed C-V2X traffic with minor adjustment to the C-V2X scheduling protocol.

During scheduling, the number of subchannels 302 or, more specifically, the number of CSRs, used for the transmission is based on the size of the data packet. In a non-limiting example, data packets that are less than 390 bytes employ two contiguous subchannels 302, data packets more than 1063 bytes employ all 10 subchannels 302, and data packets between 390 and 1063 bytes employ “X” number of contiguous subchannels, where “X” is greater than 2 and less than 10, and is selected based on the C-V2X. Typically, a BSM is transmitted using two contiguous subchannels 302.

As described herein, when C-V2X traffic is not congested or when the size of the data packet can be accommodated based on the CSR pool associated with the set of primary subchannels 302B, the scheduler 114 is configured to select one or more CSRs associated with the set of primary subchannels 302B to transmit the data packet. Alternatively, when C-V2X traffic is high (i.e., congestion) and/or when a larger data packet is to be sent that cannot fit in remaining CSR pool then this ER restriction is removed.

For example, referring to FIG. 3B, a schedule 350 having the subchannels 302, the subframes 304, and the RB 305 illustrates the CSR pool without the restriction. Specifically, the CSR pool includes subframe resources associated with the set of secondary subchannels 302A (i.e., subchannels 1, 2, and 10 of FIG. 3A) and the set of primary subchannels 302B (i.e., subchannels 3-9 of FIG. 3A). Accordingly, the data packet may be assigned to any available CSR from among the CSR pool. As illustrated between FIGS. 3A and 3B, the number of CSRs employed for transmitting data packets, which is provided as the shaded RB 305B, can be increased when certain conditions (e.g., data packet size and/or transmission availability) are met.

In some variations, if the set of secondary subchannels 302A are employed, the scheduler 114 is configured to employ the secondary subchannels 302A farthest away from a channel having high OOBE interference, such as those channels at the edge of the ITS band. For example, with N=2, perhaps the lowest subchannel 302 is still not used.

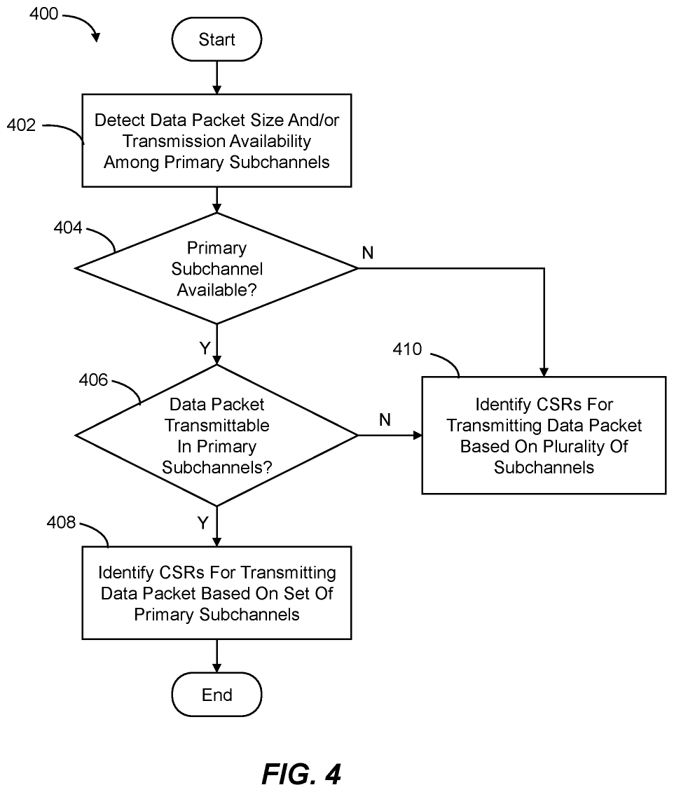

Referring to FIG. 4, an example selective excluded resource mode routine 400 executed by the V2X controller 108 having the scheduler 114 is provided. At operation 402, the V2X controller 108 detects a size of the data packet to be transmitted and a transmission availability of the data packet among the set of primary subchannels. For example, based on C-V2X protocol having defined message models, the V2X controller 108 is configured to determine the size of the data packet to be transmitted and the number of contiguous subchannels needed to transmit the data packet.

At operation 404, the V2X controller 108 determines if a primary subchannel 302B among the plurality of subchannels is available to transmit the data packet for a selected subframe. That is, based on the schedule of the ITS band managed by the scheduler 114, the V2X controller 108 is able to determine if one or more primary subchannels 302B are available to transmit the data packet for the selected subframe 304. Stated differently, the V2X controller 108 determines if data packet may be transmitted among the CSR pool defined by the set of primary subchannels 302B.

If one or more primary subchannels is available, the V2X controller 108 determines, at operation 406, whether the data packet is transmittable using the available primary subchannels 302B. Specifically, the V2X controller determines if the size of the data packet can be accommodated in available contiguous primary subchannels 302B for the selected subframe 304 (i.e., accommodated in an available CSR among the CSR pool). The available contiguous primary subchannels 302B may define a packet size threshold employed for determining if the data packet can be transmitted.

If the data packet can be accommodated, then, at operation 408, the V2X controller 108 identifies one or more candidate subchannels from among the set of primary subchannels 302B available for the selected subframe 304 for transmitting the data packet. Stated differently, the V2X controller identifies one or more CSRs associated with the set of primary subchannels 302B for transmitting the data packet.

If primary subchannels are not available or the data packet cannot be accommodated in the primary subchannels 304B available, the V2X controller 108, at operation 410, removes the ER restriction and identifies candidate subject channels for transmitting the data packet from among the plurality of subchannels 302. That is, the scheduler 114 employs both the set of primary subchannels 302B and the set of secondary channels 302A to identify contiguous candidate subchannels for transmitting the data packet. Stated differently, the V2X controller 108 identifies one or more CSRs associated with the plurality of subchannels for transmitting the data packet.

Once selected, the V2X controller 108 is configured to transmit the data packet via the antenna 110 based on the one or more CSRs identified.

The scheduler 114 may also be operable in an unrestricted mode during which the V2X controller 108 is configured to select one or more candidate subchannels 302 for transmitting the data packet from among the plurality of subchannels 302 for a selected subframe 304. That is, the scheduler 114 does not restrict the transmission to the set of primary subchannels 302B based on selected conditions, and, instead, uses any of the subchannels 302.

Having both the selective excluded resource mode and the unrestricted mode may be beneficial when the vehicle 102 is generally in environments having minimal OOBE interference. In a non-limiting example, the V2X controller 108 may transition between the selective excluded resource mode and the unrestricted mode based on an environment in which the vehicle 102, and specifically, the antenna 110 is in. Specifically, the V2X controller 108 may employ the selective excluded resource mode when the antenna 110 is indoors and employ the unrestricted mode when the antenna 110 is outdoors. The C-V2X device may be more susceptible to OOBE from U-NII devices in an indoor environment than an outdoor environment, and thus, the selective excluded resource mode may be employed to schedule data packet transmission when indoors.

In a non-limiting example, to determine the environment of the antenna, 110, the V2X controller 108 monitors signals received from the antenna 110 to detect the environment of the antenna as being indoors or outdoors. An indoor environment may be detected when the signals received is at least one of a GNSS repeater signal, a sidelink synchronization signal (SLSS) employed to align transmission and emitted in a special C-V2X state in indoor environments unable to receive an original GNSS signal. Accordingly, if the signals received are original GNSS signals, the antenna is believed to be outdoor.

In the event the communication environment has high and/or spontaneous OOBE interference, the scheduler 114 may operate in the selective excluded resource mode, and thus, there is no need for the unrestricted mode

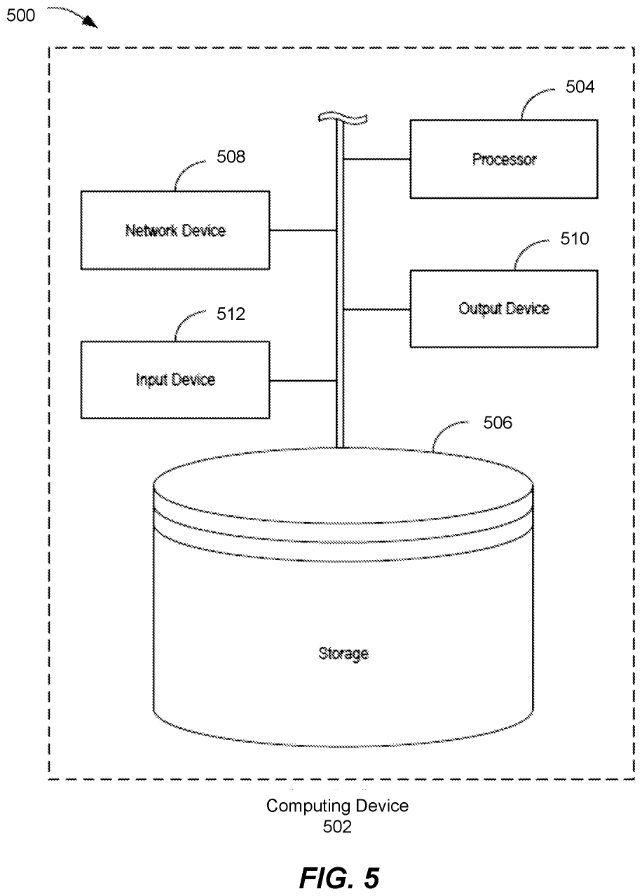

FIG. 5 illustrates an example computing device 502 for scheduling vehicle communications using a plurality of wireless interfaces. Referring to FIG. 5, and with reference to FIGS. 1-4, the ECUs 104 and TCU 106 may include examples of such computing devices 502. Computing devices 502 generally include computer-executable instructions, such as those of the scheduler 114, where the instructions may be executable by one or more computing devices 502. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein.

As shown, the computing device 502 may include a processor 504 that is operatively connected to a storage 506, a network device 508, an output device 510, and an input device 512. It should be noted that this is merely an example, and computing devices 502 with more, fewer, or different components may be used.

The processor 504 may include one or more integrated circuits that implement the functionality of a central processing unit (CPU) and/or graphics processing unit (GPU). In some examples, the processors 504 are a system on a chip (SoC) that integrates the functionality of the CPU and GPU. The SoC may optionally include other components such as, for example, the storage 506 and the network device 508 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 504 executes stored program instructions that are retrieved from the storage 506. The stored program instructions, accordingly, include software that controls the operation of the processors 504 to perform the operations described herein. The storage 506 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 510. The output device 910 may include a graphical or visual display device, such as an electronic display screen, projector, printer, or any other suitable device that reproduces a graphical display. As another example, the output device 510 may include an audio device, such as a loudspeaker or headphone. As yet a further example, the output device 510 may include a tactile device, such as a mechanically raiseable device that may, in an example, be configured to display braille or another physical output that may be touched to provide information to a user.

The input device 512 may include any of various devices that enable the computing device 902 to receive control input from users. Examples of suitable input devices 512 that receive human interface inputs may include keyboards, mice, trackballs, touchscreens, microphones, graphics tablets, and the like.

The network devices 508 may each include any of various devices that enable the described components to send and/or receive data from external devices over networks. Examples of suitable network devices 508 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A system for scheduling communications using a plurality of wireless interfaces, comprising:
an antenna configured to send and/or receive data over a message protocol having a plurality of subchannels, the plurality of subchannels including a set of primary subchannels and a set of secondary subchannels, wherein the set of primary subchannels are less susceptible to out-of-band interference than the set of secondary subchannels; and
a controller configured to employ a scheduler operable in a selective excluded resource mode, the controller being configured to:
detect a size of a data packet to be transmitted;
detect transmission availability among the set of primary subchannels;
with the scheduler in the selective excluded resource mode:
identify one or more candidate subframe resources (CSR) for transmitting the data packet based on the set of primary subchannels in response to at least one of the size of the data packet being less than a packet size threshold and at least a portion of the set of primary subchannels being available to transmit the data packet; and
identify the one or more CSR for transmitting the data packet based on the plurality of subchannels including the set of primary subchannels and the set of secondary subchannels in response to at least one of the size of the data packet being greater than or equal to the packet size threshold and the set of primary subchannels not being available to transmit the data packet; and
transmit the data packet based on the one or more CSR.

2. The system of claim 1, wherein:
the scheduler is further operable in an unrestricted mode, and
with the scheduler in the unrestricted mode, the controller is further configured to select the CSR for transmitting the data packet from among the plurality of subchannels including the set of primary subchannels and the set of secondary subchannels.

3. The system of claim 2, wherein the controller is further configured to:
monitor signals received from the antenna to detect an environment of the antenna as being indoors or outdoors,
transition the scheduler to the selective excluded resource mode in response to the antenna being indoors; and
transition the scheduler to the unrestricted mode in response to the antenna being outdoors.

4. The system of claim 3, wherein the controller is further configured to detect the signals as being at least one a global navigation satellite system (GNSS) repeater signal or a sidelink synchronization signal to detect the environment of the antenna as being indoors.

5. The system of claim 1, wherein a number of subchannels in the set of primary subchannels and a number of subchannels in the set of secondary subchannels are adjustable.

6. The system of claim 1, wherein a number of subchannels in the set of primary subchannels and a number of subchannels in the set of secondary subchannels are adjustable based on at least one of a location of the antenna, the size of the data packet, or a ProSe Per-Packet Priority (PPPP) value.

7. The system of claim 1, wherein a number of subchannels in the set of primary subchannels and a number of subchannels in the set of secondary subchannels are adjustable based on the out-of-band interference about the antenna.

8. The system of claim 1, wherein the message protocol is a cellular vehicle-to-everything (C-V2X) messaging protocol, and the out-of-band interference results from use of Wi-Fi.

9. A method for scheduling communications using a plurality of wireless interfaces, comprising:
detecting a size of a data packet to be transmitted via an antenna, wherein the antenna is configured to send and/or receive data over a message protocol having a plurality of subchannels, the plurality of subchannels including a set of primary subchannels and a set of secondary subchannels, wherein the set of primary subchannels are less susceptible to out-of-band interference than the set of secondary subchannels;
detecting transmission availability among the set of primary subchannels;
identifying, by a scheduler in a selective excluded resource mode, one or more candidate subframe resources (CSR) for transmitting the data packet based on the set of primary subchannels in response to at least one of the size of the data packet being less than a packet size threshold and at least a portion of the set of primary subchannels being available to transmit the data packet;
identifying, by the scheduler in the selective excluded resource mode, the one or more CSR for transmitting the data packet based on the plurality of subchannels including the set of primary subchannels and the set of secondary subchannels in response to at least one of the size of the data packet being greater than or equal to the packet size threshold and the set of primary subchannels not being available to transmit the data packet; and
transmitting the data packet based on the one or more CSR.

10. The method of claim 9, further comprising: selecting, by the scheduler in an unrestricted mode, the one or more CSR for transmitting the data packet based on the plurality of subchannels including the set of primary subchannels and the set of secondary subchannels.

11. The method of claim 10, further comprising:
monitoring signals received from the antenna to detect an environment of the antenna as being indoors or outdoors;
transitioning the scheduler to the selective excluded resource mode in response to the antenna being indoors; and
transitioning the scheduler to the unrestricted mode in response to the antenna being outdoors.

12. The method of claim 11, further comprising detecting the signals as being at least one of a global navigation satellite system (GNSS) repeater signal or a sidelink synchronization signal to detect the environment of the antenna as being indoors.

13. The method of claim 9, further comprising adjusting a number of subchannels in the set of primary subchannels and a number of subchannels in the set of secondary subchannels based on at least one of a location of the antenna, the size of the data packet, or a ProSe Per-Packet Priority (PPPP) value.

14. The method of claim 9, further comprising adjusting a number of subchannels in the set of primary subchannels and a number of subchannels in the set of secondary subchannels based on the out-of-band interference about the antenna.

15. The method of claim 9, wherein the message protocol is a cellular vehicle-to-everything (C-V2X) messaging protocol, and the out-of-band interference results from use of Wi-Fi.

16. A non-transitory computer-readable medium comprising instructions for scheduling communications using a plurality of wireless interfaces that, when executed by a processor of a controller, cause the controller to perform operations including to:
detect a size of a data packet to be transmitted using a message protocol;
detect transmission availability among a set of primary subchannels, wherein a plurality of subchannels for transmitting the data packet over the message protocol includes a set of primary subchannels and a set of secondary subchannels, wherein the set of primary subchannels are less susceptible to out-of-band interference than the set of secondary subchannels;
identify, by a scheduler in a selective excluded resource mode, one or more candidate subframe resources (CSR) for transmitting the data packet based on the set of primary subchannels in response to at least one of the size of the data packet being less than a packet size threshold and at least a portion of the set of primary subchannels being available to transmit the data packet; and
identify, by the scheduler in the selective excluded resource mode, the one or more CSR for transmitting the data packet based on the plurality of subchannels including the set of primary subchannels and the set of secondary subchannels in response to at least one of the size of the data packet being greater than or equal to the packet size threshold and the set of primary subchannels not being available to transmit the data packet; and
transmit the data packet based on the one or more CSR.

17. The medium of claim 16, further comprising instructions, that, when executed by the processor of the controller, cause the controller to perform operations including to: select, by the scheduler in an unrestricted mode, the one or more CSR for transmitting the data packet based on the plurality of subchannels including the set of primary subchannels and the set of secondary subchannels.

18. The medium of claim 17, further comprising instructions, that, when executed by the processor of the controller, cause the controller to perform operations including to:
monitor signals received from an antenna to detect an environment of the antenna as being indoors or outdoors, wherein the antenna is configured to send and/or receive data over the message protocol having the plurality of subchannels,
transition the scheduler to the selective excluded resource mode in response to the antenna being indoors; and
transition the scheduler to the unrestricted mode in response to the antenna being outdoors.

19. The medium of claim 18, further comprising instructions, that, when executed by the processor of the controller, cause the controller to perform operations including to detect the signals as being at least one of a global navigation satellite system (GNSS) repeater signal or a sidelink synchronization signal to detect the environment of the antenna as being indoors.

20. The medium of claim 16, wherein number of subchannels in the set of primary subchannels and number of subchannels in the set of secondary subchannels are adjustable.
